(19) United States
(12) Patent Application Publication
(10) Pub. No.: US 2016/0174526 A1
(43) Pub. Date: Jun. 23, 2016

(54) DRAGGING SOUND PRODUCTION DEVICE

(71) Applicant: Tongfu Manufacturing Co., Ltd., Nanjing (CN)

(72) Inventors: Yaomin MA, Nanjing (CN); Wen ZHANG, Nanjing (CN)

(21) Appl. No.: 14/575,044

(22) Filed: Dec. 18, 2014

(51) Int. Cl. A01K 15/02; A63H 33/00

(52) U.S. Cl. CPC A01K 15/025; A63H 33/00

(57) ABSTRACT

Utility model relates to a sound production device, and in particular, to a pull-mode sound production device. A pull-mode sound production device is provided, which separates two uses states of an existing sound production device, that is, cavity deformation and sound production by a squeaker, in which sound production device does not trigger squeaker to produce sound during a cavity deformation process, and then a toy can be squeezed without producing any sound. The pull-mode sound production device includes a sound production cavity, where it is hollow, and a squeaker mounting hole and air vent are separately provided on a cavity wall of sound production cavity; further includes a squeaker, where squeaker is mounted its mounting hole; and further includes an air vent control assembly, which includes a plug and a pull cord, the pull cord is secured on an outer side of plug, and plug matches air vent.

### BACKGROUND

1. Technical Field

The present utility model belongs to the filed of pet products, relates to a sound production device, and in particular, to a pull-mode sound production device.

2. Related Art

A squeaker is a frequently used part of a sound production device, which can be effectively controlled to produce sound or not by controlling an air stream to pass through the squeaker or not; in addition, the sound production frequency of the squeaker can be controlled by controlling the amount of the air stream that passes through the squeaker; and in this way, variable sound can be produced.

Therefore, during use of the squeaker, the situation that the air stream is effectively controlled to pass through the squeaker is a key part to the use of the squeaker.

In the conventional art, the situation that the air stream passes through the squeaker is not controlled generally, and therefore, a sound production state of the sound production device is uncontrollable. As a result, sound is inevitably produced when a cavity is squeezed, and if it is not required to make a sound, the cavity should not be squeezed.

In order to increase the attraction of pet toys, a sound production device is used in a toy. Toys of that kind usually produce sound of high frequency to attract a pet and excite a pet. However, it brings some side effects: when a person stays with a pet, if the pet keeps triggering the sound production device, the person will feel annoyed. This problem can be solved by putting the toy away, and however, the pet may find the toy again or may be emotionally affected. Therefore, a switch method not only can control whether a toy produces sound or not, but also take care of the emotion of a pet.

### SUMMARY

The present utility model provides a pull-mode sound production device, which separates two uses states of an existing sound production device, that is, cavity deformation and sound production by a squeaker, so that the sound production device does not trigger the squeaker to produce sound during a cavity deformation process, and then a toy can be squeezed without producing any sound.

Specific technical solutions are as follows:

1. A pull-mode sound production device includes a sound production cavity, where the sound production cavity is hollow, and a squeaker mounting hole and an air vent are separately provided on a cavity wall of the sound production cavity; further includes a squeaker, where the squeaker is mounted in the squeaker mounting hole; and further includes an air vent control assembly, where the air vent control assembly includes a plug and a pull cord, the pull cord is secured on an outer side of the plug, and the plug matches the air vent.

2. Further, a through hole is provided on the plug; and the pull cord runs through the through hole, and forms a stopping relationship with the plug by using a protruding knot.

3. Further, the plug is in transition fit or interference fit with the air vent.

4. Moreover, on the basis of the technical solution 2, the protruding knot is a cord knot.

5. Finally, preferably, the cavity wall of the sound production cavity is formed by clamping an upper part and a lower part, and the air vent is provided at a position where the upper cavity wall and the lower cavity wall are clamped.

The present utility model has the following beneficial effects in comparison with the prior art:

1. With the squeaker mounting hole and the air vent, the squeaker is in an on state all the time, and never in an off state; and sound production of the squeaker completely depends on opening/closure of the air vent.

By a fit between the pull cord and the plug, when the pull cord is pulled, the plug moves relative to the air vent, and the air vent is plugged and closed, so that an air stream is entirely or partially prevented from passing through the air vent. When it is not required to make a sound, the plug is pushed into the cavity, the air vent is opened, and the air stream first passes through the air vent; in this way, the squeaker is not triggered and no sound is produced.

2. The pull cord may be secured on the plug by gluing or by using a fixture; and in the present utility model, a protruding knot is used preferably, and more preferably, a cord knot is used, so as to facilitate assembly and save the product cost.

3. Further, the plug is preferably in transition fit or interference fit with the air vent, so that the air stream can be controlled more precisely.

4. Furthermore, in the present utility model, preferably, the cavity wall of the sound production cavity is formed by clamping an upper part and a lower part, and the air vent is provided at a position where the upper cavity wall and the lower cavity wall are clamped, thereby facilitating assembly of the sound production device, simplifying an assembly process, and saving an assembly time.

To sum up, in the technical solutions disclosed by the present utility model, by using a simple structure, namely, a pull cord, separation of a squeaker and a sound production cavity can be effectively controlled, thereby achieving high practicability.

### BRIEF DESCRIPTION OF THE DRAWINGS

The disclosure will become more fully understood from the detailed description given herein below for illustration only, and thus are not limitative of the disclosure, and wherein:

FIG. 1 is an exploded view of a pull-mode sound production device;

FIG. 2 is a fitting diagram when a plug is in a plugging state; and

FIG. 3 is a fitting diagram when a plug is in an unplugging state.

### DETAILED DESCRIPTION

### Embodiment 1

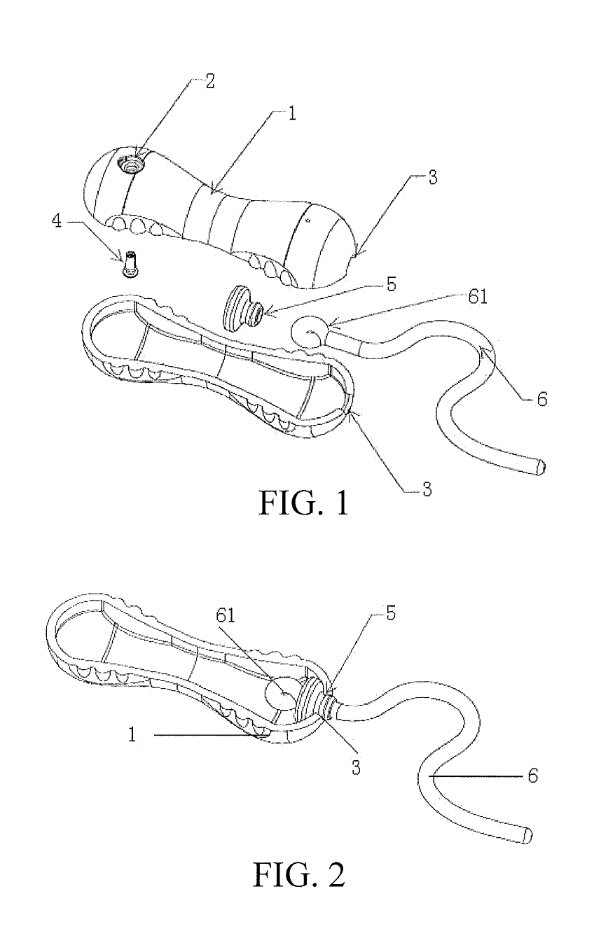

FIG. 1 shows a pull-mode sound production device. As shown in FIG. 1, the pull-mode sound production device includes a sound production cavity 1, where the sound production cavity 1 is hollow, and a squeaker mounting hole 2 and an air vent 3 are separately provided on a cavity wall of the sound production cavity 1; further includes a squeaker 4, where the squeaker 4 is mounted in the squeaker mounting hole 2; and further includes an air vent control assembly, where the air vent control assembly includes a plug 5 and a pull cord 6, the pull cord 6 is secured on an outer side of the plug 5, and the plug 5 matches the air vent 3.

Preferably, in this embodiment, the plug 5 is fitted with the pull cord 6 by a cord knot 61, as shown in FIG. 2.

In a normal state, when the pull cord 6 is pulled, the plug 5 is driven to plug the air vent 3, as shown in FIG. 2. In this way, the sound production cavity is closed, and if the sound production cavity is squeezed in this case, an air stream flows out of the squeaker mounting hole 2 to trigger an inner reed of the squeaker, so that the squeaker produces sound.

The sound production control principle of this structure is not to block or cover an air vent of a squeaker so as to control whether sound is produced or not, but to control, by an additional air channel, air to pass through the air vent of the squeaker so as to control whether sound is produced or not. This is the key, as for whether the additional air vent is opened or closed by using a plug with a cord or through other actions such as pulling or rotating, all these manners are included in this application. This application also has an advantage: when a squeaker switch is implemented, no closed container is formed as a closed container may explode when bitten by a pet, especially a big pet, and the explosion may result in an accident or destroy the toy.

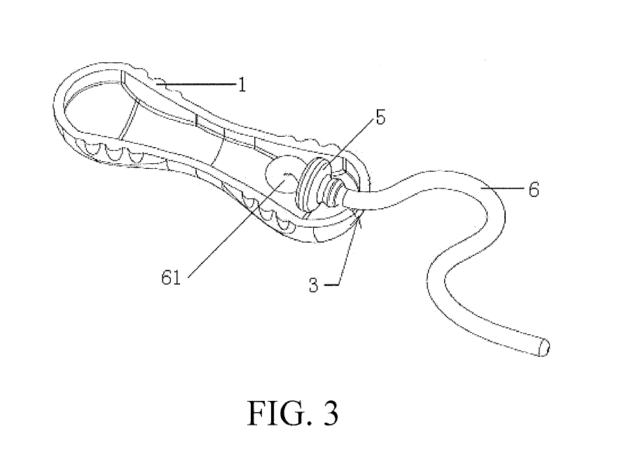

When it is not required to make a sound and the sound produce device only needs to be squeezed, as shown in FIG. 3, the plug 5 is pushed into the sound production cavity, and then the air vent 3 is opened; when the sound production cavity is squeezed, the air stream flows out of the air vent 3 first, and does not trigger the inner reed of the squeaker, so that the sound production device does not produce sound when being squeezed.

A person skilled in the art should understand that they may still make modification, equivalent replacement, or improvement without departing from the principle of the present invention. Therefore, modification, equivalent replacement, or improvement made according to the principle of the present invention shall fall within the scope of the present invention.

What is claimed is:

1. A pull-mode sound production device, comprising a sound production cavity, wherein the sound production cavity is hollow, and a squeaker mounting hole and an air vent are separately provided on a cavity wall of the sound production cavity; further comprising a squeaker, wherein the squeaker is mounted in the squeaker mounting hole;
and further comprising an air vent control assembly, wherein the air vent control assembly comprises a plug and a pull cord, the pull cord is secured on an outer side of the plug, and the plug matches the air vent.

2. The pull-mode sound production device according to claim 1, wherein a through hole is provided on the plug; and the pull cord runs through the through hole, and forms a stopping relationship with the plug by using a protruding knot.

3. The pull-mode sound production device according to claim 1, wherein the plug is in transition fit or interference fit with the air vent.

4. The pull-mode sound production device according to claim 2, wherein the protruding knot is a cord knot.

5. The pull-mode sound production device according to claim 2, wherein the cavity wall of the sound production cavity is formed by clamping an upper part and a lower part, and the air vent is provided at a position where the upper cavity wall and the lower cavity wall are clamped.
